(19) United States
(12) Patent Application Publication
(10) Pub. No.: US 2015/0083865 A1
(43) Pub. Date: Mar. 26, 2015

(54) MULTIPLE SPACECRAFT LAUNCH SYSTEM

(71) Applicant: The Boeing Company, Chicago, IL (US)

(72) Inventor: Dennis Y. Nakasone, Redondo Beach, CA (US)

(73) Assignee: The Boeing Company, Chicago, IL (US)

(21) Appl. No.: 14/034,328

(22) Filed: Sep. 23, 2013

(51) Int. Cl. B64G 1/24; B64G 1/44; B64G 1/40

(52) U.S. Cl. CPC B64G 1/242; B64G 1/40; B64G 1/443
USPC 244/158.6; 244/171.5; 244/164

(57) ABSTRACT

A system and method for propelling spacecraft is disclosed. An electrical propulsion system is mounted on a base stage. A plurality of spacecraft couplers are also mounted on the base stage. Each spacecraft coupler securedly attaches a spacecraft to the base stage. Each spacecraft includes an internal power source that is coupled to the electrical propulsion system via an electrical connection. The internal power source consists of solar panels and/or batteries. A power regulation circuit is coupled between the electrical propulsion system and each internal power source. The power regulation circuit is draws an equal and proportional amount of power from each spacecraft. The spacecraft are preferably satellites and the electrical propulsion system preferably propels the base stage and attached satellites from a lower-Earth orbit to a higher-Earth orbit so that the electrical propulsion system in each satellite need only be capable of providing propulsion for orbit maintenance and maneuvering.

### FIELD

This invention relates generally to a spacecraft launch system and method.

### BACKGROUND

Many modern satellites are designed to be deployed in a Geostationary Earth Orbit (GEO), rather than a Lower Earth Orbit (LEO). A GEO is a higher-Earth orbit and the cost of launching a satellite into a GEO (or other higher-Earth orbits such as Medium Earth Orbit and Highly Elliptical Orbit) is significantly higher than launching into an LEO. To reduce the launch costs, a satellite may instead be launched into a much lower parking or transfer orbit and then moved to a higher-Earth orbit using a propulsion system incorporated into the satellite. A solar electric propulsion thruster system is now commonly used in such satellites, which typically includes solar arrays, at least one energy storage device, a propellant fuel storage tank, control electronics and a thruster engine. Examples of solar electric propulsion thruster systems include, for example, a Xenon ion propulsion thruster, a Hall Effect thruster, an ion thruster, a pulsed induction thruster, a FARAD, and a VASIMR. The traditional propulsion system required in a satellite (or other type of spacecraft) necessary for movement from a parking or transfer orbit to a higher-Earth orbit is significantly larger and consequently heavier and more expensive than the propulsion systems included in satellites launched directly into a higher-Earth orbit since such systems are used only for maintaining orbit and for orbit correction.

### SUMMARY

The present disclosure is addressed to a system and method for propelling spacecraft. The system includes a common base stage, an electrical propulsion system mounted on the base stage, and one or more spacecraft couplers mounted on the base stage. Each of the spacecraft couplers is configured to securedly attach a spacecraft to the base stage. Each spacecraft includes an internal power source. Each spacecraft coupler preferably includes an electrical connection for coupling the internal power source to the electrical propulsion system. Each electrical connection may also be configured to transfer control signals between a controller within the associated spacecraft and a controller coupled to the electrical propulsion system. The internal power source may comprise at least one solar collecting component and/or at least one battery. A power regulation circuit may be coupled between the electrical propulsion system and each internal power source. The power regulation circuit is preferably configured to draw an equal and proportional amount of power from each spacecraft. Each spacecraft may be a satellite and the electrical propulsion system may be configured to propel the base stage and attached satellites from a lower-Earth orbit to a higher-Earth orbit. Each satellite preferably includes an associated electrical propulsion system that is only capable of providing propulsion for orbit maintenance and maneuvering and is not capable of providing propulsion for orbit raising from a lower-Earth orbit to a higher-Earth orbit.

In a further embodiment, the system also includes a non-spacecraft coupler mounted on the base stage which is configured to securedly attach a non-spacecraft storage container to the base stage.

In a still further embodiment, the system also includes a spacecraft portion permanently affixed to the base stage. The spacecraft portion may be a satellite portion.

According to the method for propelling a spacecraft, a plurality of spacecraft are securedly attached to a base stage having an electrical propulsion system mounted thereon. An electrical power source in each of the plurality of spacecraft is coupled to the electrical propulsion system. The electrical propulsion system is operated to propel the base stage and attached spacecraft using electrical power from each electrical power source. Further, a controller within the associated spacecraft may be coupled to a controller coupled to the electrical propulsion system in the base stage, to transfer control signals between the controller within associated spacecraft and the controller coupled to the electrical propulsion system. Still further, a power regulation circuit may be coupled between the electrical propulsion system and each internal power source. The power regulation circuit may be configured to draw an equal and proportional amount of power from each spacecraft. In the method, each spacecraft may be a satellite, with the electrical propulsion system is configured to propel the base stage and attached satellite from a lower-Earth orbit to a higher-Earth orbit. Each satellite may include an associated electrical propulsion system that is only capable of providing propulsion for orbit maintenance and maneuvering and which is not capable of providing propulsion for orbit raising from a lower-Earth orbit to a higher-Earth orbit.

### BRIEF DESCRIPTION OF THE DRAWINGS

The following detailed description, given by way of example and not intended to limit the present invention solely thereto, will best be understood in conjunction with the accompanying drawings in which:

FIGS. 1A, 1B and 1C are diagrams of a first embodiment of the present invention showing multiple satellites and solar collecting components attached to a structural member;

FIG. 2 is a block diagram of the drive system for the first embodiment;

FIG. 3 is a diagram of a second embodiment of the present invention; and

FIG. 4 is a diagram of a third embodiment of the present invention.

### DETAILED DESCRIPTION

In the present disclosure, like reference numbers refer to like elements throughout the drawings, which illustrate various exemplary embodiments of the present invention. The embodiments disclosed herein provide a spacecraft launch system for moving a plurality of spacecraft (e.g., satellites) and/or non-spacecraft storage containers from a lower parking or transfer orbit to a higher-Earth orbit. The parking or transfer orbit may be an LEO or may simply be any desired orbit lower than a higher-Earth orbit. The system employs a common solar electric propulsion stage (base) that mates with a plurality of spacecraft and receives electrical power from the spacecraft (e.g., generated by solar collecting components mounted on such spacecraft). The solar collecting components may be solar panels. As explained in more detail below, the common propulsion stage includes a solar electric engine and associated propellant storage tank of the type required for the orbit-raising operation (i.e., the movement from the lower parking or transfer orbit to the higher-Earth orbit). Using a common propulsion stage eliminates the need for such costly parts on each spacecraft. Instead, each spacecraft will only require a smaller, lighter and much less expensive solar electric engine and associated propellant tank used only in orbit maintenance and maneuvering.

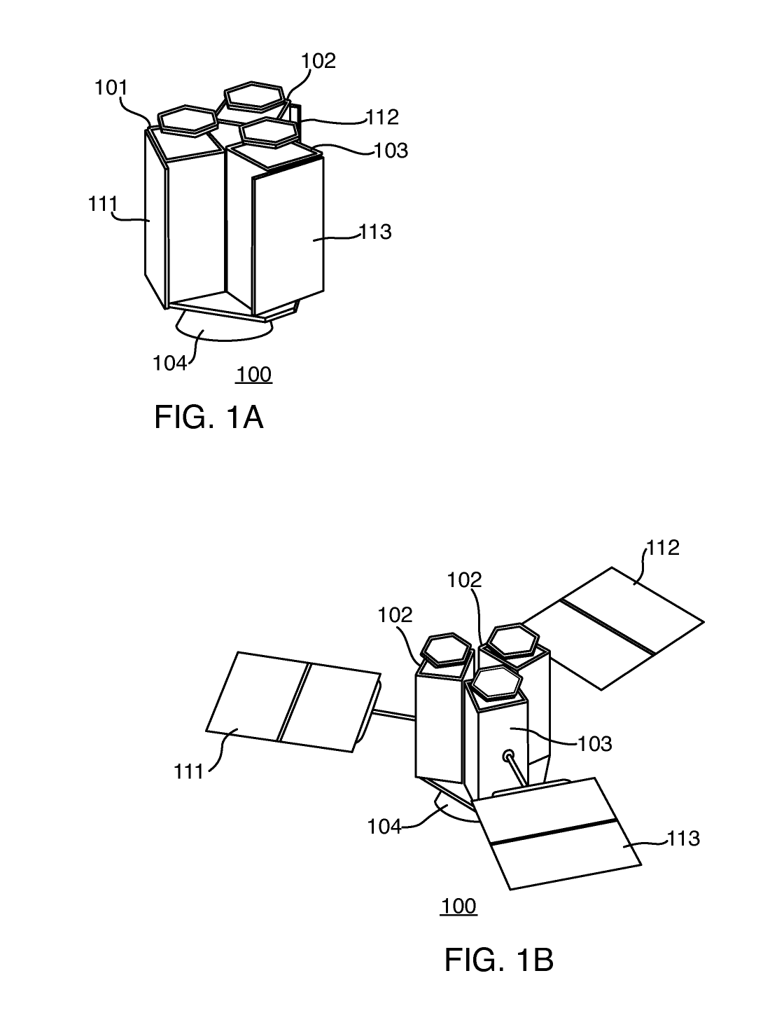

Referring now to the drawings and in particular to FIGS. 1A, 1B and 1C, a first embodiment, system 100, is shown which includes a base stage 104 that is coupled to three separate satellites 101, 102, 103. Although the Figures herein refer to satellites, one of ordinary skill in the art will readily recognize that other types of spacecraft may also be used in conjunction with the disclosed embodiments. FIG. 1A shows system 100 with the solar panels 111, 112 and 113 refracted (i.e., in the stowed position for launch to the lower parking or transfer orbit) while FIG. 1B shows system 100 with solar panels 111, 112, 113 deployed (i.e., in the orbit-raising position). FIG. 1C shows the details of an exemplary base stage 104, which may include at least one common propulsion engine 141, an associated propellant storage tank 142 and a base portion 143 (a main structural member) that includes, for example, three couplers 121, 122, 122 for providing mechanical and electrical connections to a corresponding coupler (not shown) on each respective satellite 101, 102, 103.

After system 100 is launched into the lower parking or transfer orbit on a launching rocket, it separates from the launching rocket and may perform an orbit-raising operation (i.e., the transition from the lower parking or transfer orbit to a desired higher-Earth orbit). During orbit raising, each satellite 101, 102, 103 may provide electrical power to the common propulsion engine 141 on base stage 104 (via the solar panels 111, 112, 113 and internal batteries in each satellite). In this manner, the solar panels 111, 112, 113 for each satellite 101, 102, 103 (and an associated internal power regulation/control system and internal battery) may be deployed to provide one-third of the electrical power necessary for the common propulsion engine 141 (since each satellite provides a proportional portion of the power needed for base stage 104). As discussed below, the inclusion of three satellites 101, 102, 103 on base stage 104 is merely exemplary and one of ordinary skill in the art will readily recognize that the electrical power requirements supplied to base stage 104 from the satellite is a fractional proportion determined by the number of satellites mounted on base stage 104. The use of a common propulsion engine 141 eliminates the need for a larger propulsion engine and larger associated propellant storage tank for each satellite 101, 102, 103. The system 100, after deployment at the lower parking or transfer orbit, moves up to a position near to the desired higher-Earth orbit, and then each satellite 101, 102, 103 is detached and moved into the final desired orbit. By eliminating the propulsion engine and associated propellant storage tank (sized for an orbit raising operation) from each satellite, significant cost-savings and weight-savings can be achieved for each satellite.

As one of ordinary skill in the art will readily recognize, the number of satellites included on base stage 104 is an arbitrary design choice. The benefits provided by the embodiment of FIGS. 1A, 1B and 1C can be achieved even when base stage 104 is designed to include only two satellites (each providing a portion of the power needed for the common propulsion engine 141). Furthermore, the maximum number of satellites that can be attached to base stage 104 is a design choice that depends upon the size of the satellites to be launched and upon the space available within the rocket used to launch the system 100 into the lower parking or transfer orbit. Still further, in some circumstances one or more of the spacecraft attached to base stage 104 may not have solar panels but may instead only include one or more batteries as the internal power source. Finally, base stage 104 may even be designed to couple to only a single satellite. In this case, the satellite will need to include an electrical power source which provides all the power necessary for the propulsion engine. This latter further embodiment may be desirable to reduce the size and weight of the satellite (since it will not need the larger propulsion engine and associated propellant tank) to extend the life of the satellite, for example, based on the lighter weight.

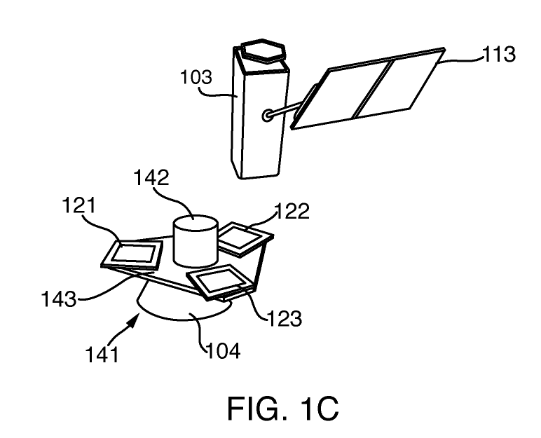

FIG. 2 is a block diagram that shows the components and electrical connections between each satellite 210, 220, 230 and the base stage 200 (corresponding to system 100). Each satellite 210, 220, 230 includes an associated solar array 211, 221, 231 that is coupled to an associated power regulation and control circuit 212, 222, 232. The power regulation and control circuit 212, 222, 232 operates under the control of associated SV control processer 213, 223, 233. An associated internal battery 215, 225, 235 is also coupled to each power regulation and control circuit 212, 222, 232 for storage of the energy from the solar arrays 211, 221, 231. Loads 214, 224, 234 represent the internal current draw from each power regulation and control circuit 212, 222, 232 for circuits within each satellite 210, 220, 230. Finally, each satellite 210, 220, 230 includes a connection 216, 226, 236 to a bus connector 240 for coupling power and command signals from the respective satellites 210, 220, 230 to base stage 200. In particular, a shared electrical power regulation circuit 204 receives the power and command signals from bus connector 240 and supplies common power and command signals to the solar electric propulsion control circuits 203. Solar electric propulsion control circuits 203 control the electric propulsion engines 201, 202.

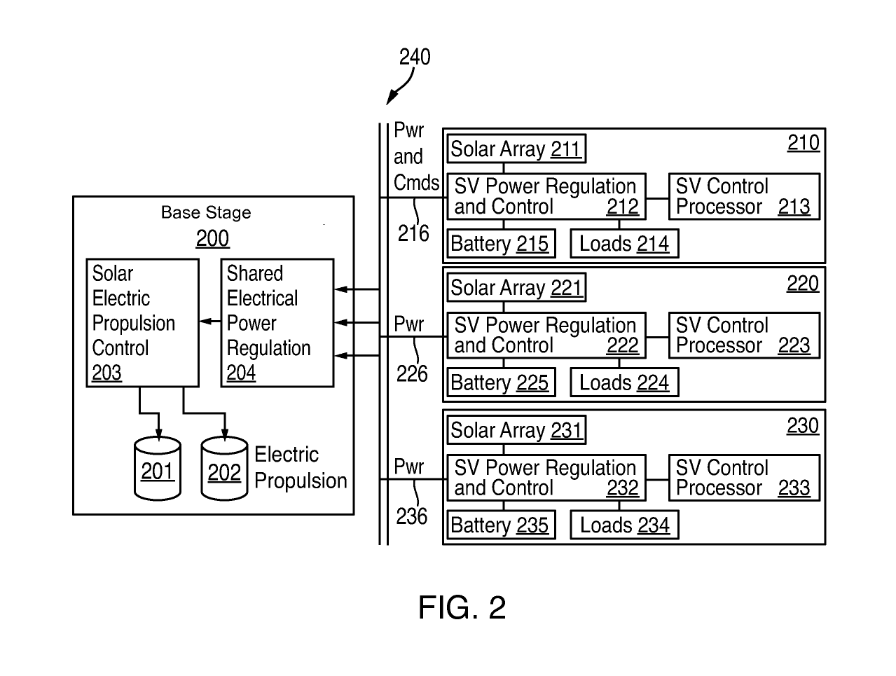

FIG. 3 shows a first alternative embodiment in which a base stage 300 includes a platform 350 holding a propellant storage tank 340 for the propulsion engine and three couplers 310, 320, 330 for connecting to detachable satellites as in the FIGS. 1A, 1B, 1C embodiment. However, in this embodiment, base stage 300 also includes a carrier 360 for use in transporting equipment or materials from the lower parking or transfer orbit to the higher-earth orbit. Carrier 360 is essentially a shipping container of comparable size to the satellites coupled to couplers 310, 320, 330. Base stage 300 operates otherwise the same as in the FIGS. 1A, 1B, 1C embodiment. In this manner, base stage 300 can, for example, deliver the three satellites coupled to couplers 310, 320, 330 into a higher-earth orbit and also deliver equipment or materials to a space station that is also in the higher earth orbit. Carrier 360 may be permanently affixed to base stage 300, or may be detachably affixed such that it can be removed, e.g., via a remote controlled arm at the space station.

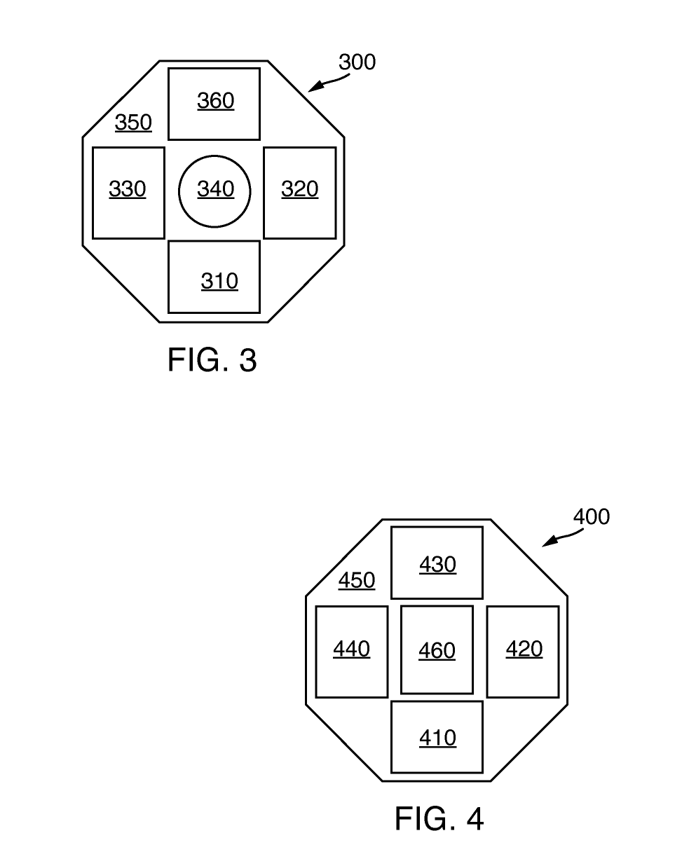

FIG. 4 shows a second alternative embodiment in which a base stage 400 includes a platform 450 holding four couplers 410, 420, 430, 440 for connecting to detachable satellites in a manner similar to the FIGS. 1A, 1B, 1C embodiment. In addition, a permanently-affixed spacecraft or satellite portion 460 is also connected to platform 450 on base stage 400. Spacecraft or satellite portion 460 includes an integral propellant storage tank sized large enough for the orbit-raising operation and the remaining components required for a single spacecraft or satellite. When spacecraft or satellite portion 460 is a satellite, the required solar panel and associated battery (not shown) may be fractionally sized (e.g., one-fifth the size necessary for orbit-raising). Base stage 400 may be more expensive than the satellites that couple to couplers 410, 420, 430, 440 due to the added expense required for the couplers and orbit-raising engine. However, this added cost can be outweighed by the savings afforded by the reduced cost for the other four satellites.

Although the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A system for propelling spacecraft, comprising:
a base stage containing at least one electrical propulsion system; and
a plurality of spacecraft couplers mounted on the base stage, each spacecraft coupler configured to securedly attach a spacecraft to the base stage.

2. The system of claim 1, wherein each spacecraft includes an internal power source and wherein each spacecraft coupler includes an electrical connection for coupling the internal power source to the electrical propulsion system.

3. The system of claim 2, wherein each electrical connection is also configured to transfer control signals between a controller within the associated spacecraft and a controller coupled to the electrical propulsion system.

4. The system of claim 2, wherein the internal power source comprises at least one solar-collecting component.

5. The system of claim 2, wherein the internal power source comprises at least one battery.

6. The system of claim 2, further comprising a power regulation circuit coupled between the electrical propulsion system and each internal power source, the power regulation circuit configured to draw an equal and proportional amount of power from each spacecraft.

7. The system of claim 1, wherein each spacecraft is a satellite and wherein the electrical propulsion system is configured to propel the base stage and attached satellites from a lower-Earth orbit to a higher-Earth orbit.

8. The system of claim 7, wherein each satellite includes an associated electrical propulsion system that is only capable of providing propulsion for orbit maintenance and maneuvering and is not capable of providing propulsion for orbit raising from a lower-Earth orbit to a higher-Earth orbit.

9. The system of claim 1, further comprising at least one non-spacecraft coupler mounted on the base stage and configured to securedly attach a non-spacecraft storage container to the base stage.

10. The system of claim 1, further comprising a spacecraft portion permanently affixed to the base stage.

11. The system of claim 10, wherein the spacecraft portion comprises a satellite portion.

12. A system for propelling spacecraft, comprising:
a base stage containing an electrical propulsion system mounted on the base stage; and
at least one spacecraft coupler mounted on the base stage and configured to securedly attach a spacecraft to the base stage.

13. The system of claim 12, wherein the spacecraft is a satellite and wherein the electrical propulsion system is configured to propel the base stage and attached spacecraft from a lower-Earth orbit to a higher-Earth orbit.

14. The system of claim 13, wherein the satellite includes an associated electrical propulsion system that is only capable of providing propulsion for orbit maintenance and maneuvering and is not capable of providing propulsion for orbit raising from a lower-Earth orbit to a higher-Earth orbit.

15. A method for propelling spacecraft, comprising the steps of:
securedly attaching at least two spacecraft, each having an internal electrical power source, to a base stage having at least one electrical propulsion system mounted thereon;
coupling the electrical power source in each of the plurality of spacecraft to the electrical propulsion system; and
operating the electrical propulsion system to propel the base stage and attached spacecraft using electrical power from each electrical power source.

16. The method of claim 15, further comprising the step of electrically coupling a controller within the associated spacecraft and a controller coupled to the electrical propulsion system to transfer control signals between the controller within associated spacecraft and the controller coupled to the electrical propulsion system.

17. The method of 15, further comprising the step of coupling a power regulation circuit between the electrical propulsion system and each internal power source, the power regulation circuit configured to draw an equal and proportional amount of power from each spacecraft.

18. The method of claim 15, wherein each spacecraft is a satellite, wherein the electrical propulsion system is configured to propel the base stage and attached satellites from a lower-Earth orbit to a higher-Earth orbit, and wherein each satellite includes an associated electrical propulsion system that is only capable of providing propulsion for orbit maintenance and maneuvering and is not capable of providing propulsion for orbit raising from a lower-Earth orbit to a higher-Earth orbit.

19. The method of claim 15, further comprising the step of mounting at least one non-spacecraft coupler on the base stage, the non-spacecraft coupler configured to securedly attach a non-spacecraft storage container to the base stage.

20. The method of claim 15, further comprising the step of permanently affixing a spacecraft portion to the base stage.
